(19) United States
(12) Patent Application Publication
(10) Pub. No.: US 2026/0099140 A1
(43) Pub. Date: Apr. 9, 2026

(54) ASSET OPERATION ANOMALY DETERMINATION

(71) Applicant: Honeywell International Inc., Charlotte, NC (US)

(72) Inventor: Alexander Zelichenko, Kochav Yair (IL)

(21) Appl. No.: 18/908,834

(22) Filed: Oct. 8, 2024

(51) Int. Cl. G05B 23/02

(52) U.S. Cl. CPC G05B 23/0254

(57) ABSTRACT

Techniques for determining an anomaly in operation of an asset are described. In operation, operation of an asset within an industrial facility is monitored to identify a silence period for the asset, where the silence period is indicative of a time duration when the asset exhibits no network activity. The silence period is then determined to be longer than a reference silence period, where the reference silence period is utilized for determining an anomaly in the operation of the asset. Based on the determination, an alarm indicative of the anomaly in the operation of the asset is generated.

### BACKGROUND

Industrial facilities encompass a wide variety of equipment and machinery essential for industrial operations. Such equipment and machinery are usually referred to as assets. During an industrial operation, the assets communicate with each other over a communication network. Further, operation of such assets within an industrial facility is usually determined in accordance with the industrial process and role played by each of the assets in the industrial process. For instance, depending on an industrial process being implemented in the industrial facility, assets may be configured to stay in operational and non-operational states for different time durations during an operation shift.

### SUMMARY

According to a first aspect, there is provided a method comprising: monitoring operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity; analyzing the activity pattern to identify a reference silence period, wherein the reference silence period is utilized for determining an anomaly in the operation of the asset; monitoring the network activity of the asset after at least the predetermined time period to identify a silence period longer than the reference silence period; and generating an alarm indicative of the anomaly in the operation of the asset.

According to some examples, the identifying the silence period comprises: receiving network statistics associated with the asset; analyzing the network statistics to identify a first timestamp corresponding to last network packet transmitted by the asset on a network; identifying a second timestamp corresponding to a current time of the network; and computing a difference between the first timestamp and the second timestamp.

According to some examples, the network statistics comprise last activity timestamp of an Internet Protocol (IP) address of the asset, where the last activity corresponds to transmission of the last network packet by the asset on the network.

According to some examples, the network statistics are comprise last activity timestamp of a Media Access Control (MAC) address of the asset, where the last activity corresponds to transmission of the last network packet by the asset on the network.

According to a second aspect, there is provided an Anomaly Determination System (ADS) comprising: a monitoring engine to monitor operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity; a learning engine coupled to the monitoring engine to: identify a reference silence period from the at least one silence period wherein the reference silence period is utilized for determining an anomaly in the operation of the asset; and reference a time duration of the reference silence period as threshold for monitoring the asset for determination of the anomaly in the operation of the asset; and an anomaly detection engine coupled to the learning engine to: monitor the network activity of the asset after at least the predetermined learning period to identify a silence period longer than the threshold; and generate an alarm indicative of the anomaly in the operation of the asset.

According to some examples, the reference silence period is a silence period with longest time duration from the at least one silence period.

According to some examples, the learning engine is to: determine the reference silence period to be shorter than a scaling threshold; scale the reference silence period based on a scaling coefficient to generate a scaled reference silence period; and reference a time duration of the scaled reference silence period as the threshold for monitoring the asset for determination of the anomaly in the operation of the asset.

According to some examples, prior to scaling the reference silence period, the learning engine is to compute the scaling coefficient based on at least one of the reference silence period, a maximum permissible value of the scaling coefficient, and a scale resolution, wherein the maximum permissible value of the scaling coefficient is determined based on at least one of the asset and an industrial process involving the asset, and the scale resolution is determined based on a time duration when the reference silence period and the scaled reference silence period are equal.

According to some examples, the learning engine is to compute the scaled reference silence period based on at least one of the maximum permissible value of the scaling coefficient, the reference silence period, an upper_bound for the at least one silence period, and a lower_bound for the at least one silence period, wherein the upper_bound is longest time duration for which the asset exhibits no network activity and is predetermined based on the industrial process involving the asset, and the lower_bound is the shortest time duration for which the asset exhibits no network activity and is predetermined based on the industrial process involving the asset.

According to some examples, to identify the silence period, the anomaly detection engine is to: receive network statistics associated with the asset; analyze the network statistics to identify a first timestamp corresponding to last network packet transmitted by the asset on a network; identify a second timestamp corresponding to a current time of the network; and compute a difference between the first timestamp and the second timestamp.

According to some examples, to identify the at least one silence period, the monitoring engine is to: receive network statistics associated with the asset; analyze the network statistics to identify a third timestamp corresponding to a first network packet transmitted by the asset and a fourth timestamp corresponding to a second network packet transmitted after the first network packet; and compute a difference between the third timestamp and the fourth timestamp.

According to some examples, the network statistics comprise last activity timestamp of an IP address of the asset, where the last activity corresponds to transmission of the second network packet by the asset on the network.

According to some examples, the network statistics comprise last activity timestamp of a MAC address of the asset, where the last activity corresponds to transmission of the second network packet by the asset on the network.

According to a third aspect, there is provided a non-transitory computer readable medium comprising computer-readable instructions that when executed cause a processing resource of a computing device to: monitor operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity; identify a reference silence period from the at least one silence period, wherein the reference silence period is to be utilized for determining an anomaly in the operation of the asset; determine the reference silence period to be shorter than a scaling threshold; scale the reference silence period based on a scaling coefficient to generate a scaled reference silence period; reference a time duration of the scaled reference silence period as threshold for monitoring the asset for determination of the anomaly in the operation of the asset; monitor the network activity of the asset after at least the predetermined learning period to identify a silence period longer than the threshold; and generate an alarm indicative of the anomaly in the operation of the asset.

According to some examples, the reference silence period is a silence period with longest time duration from the at least one silence period.

According to some examples, the instructions further cause the processing resource to compute the scaling coefficient based on at least one of the reference silence period, a maximum permissible value of the scaling coefficient, and a scale resolution, wherein the maximum permissible value of the scaling coefficient is determined based on at least one of the asset and an industrial process involving the asset, and the scale resolution is determined based on a time duration when the reference silence period and the scaled reference time period are equal.

According to some examples, the instructions further cause the processing resource to compute the scaled reference silence period based on at least one of the maximum permissible value of the scaling coefficient, the reference silence period, an upper_bound for the at least one silence period, and a lower_bound for the at least one silence period, wherein the upper_bound is longest time duration for which the asset exhibits no network activity and is predetermined based on the industrial process involving the asset, and the lower_bound is the shortest time duration for which the asset exhibits no network activity and is predetermined based on the industrial process involving the asset.

According to some examples, to identify the at least one silence period, the instructions cause the processing resource to: receive network statistics associated with the asset; analyze the network statistics to identify a third timestamp associated with a first network packet transmitted by the asset and a fourth timestamp associated with a second network packet transmitted after the first network packet; and compute a difference between the third timestamp and the fourth timestamp.

According to some examples, the network statistics comprise last activity timestamp of an IP address of the asset, where the last activity corresponds to transmission of the second network packet by the asset on the network.

According to some examples, the network statistics comprise last activity timestamp of a MAC address of the asset, where the last activity corresponds to transmission of the second network packet by the asset on the network.

### BRIEF DESCRIPTION OF DRAWINGS

FIG. 1 illustrates an environment for implementing an Anomaly Determination System (ADS), in accordance with an example of the present subject matter,

FIG. 2 illustrates schematics of the ADS, in accordance with an example of the present subject matter,

FIG. 3 illustrates the schematics of the ADS, in accordance with another example of the present subject matter,

FIG. 4 illustrates a method for determining the anomaly in the operation of the asset, in accordance with examples of the present subject matter,

FIG. 5 illustrates a method for identifying a reference silence period, in accordance with an example of the present subject matter,

FIG. 6 illustrates a method for determining the anomaly in the operation of the asset, in accordance with another example of the present subject matter,

FIG. 7 illustrates a method for identifying a scaled reference silence period, in accordance with another example of the present subject matter,

FIG. 8 illustrates a method for determining the anomaly in the operation of the asset, in accordance with yet another example of the present subject matter,

FIG. 9 illustrates a method for identifying a silence period for the asset, in accordance with an example of the present subject matter, and

FIG. 10 illustrates a non-transitory computer-readable medium for determining the anomaly in operation of the asset, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

To ensure seamless operation of the assets, operations of the assets are usually monitored and controlled. To facilitate monitoring of operations, an asset transmits operational parameters indicative of the asset's operation during the operational state to a supervisory equipment, such as an asset monitoring and control server. The supervisory equipment then analyses the operational parameters and determines if the asset's operations are compliant with the industrial process. If the asset's operations are determined to be non-compliant with the industrial process, the supervisory equipment generates control instructions to streamline the asset's operations.

In several situations, the asset may malfunction and may go into the non-operational state. In such a situation, the asset stops transmitting the operational parameters to the supervisory equipment. However, since the asset is configured to stay in both operational and non-operational states, the stoppage in transmission of the operational parameters from the asset may be misinterpreted to correspond to the non-operational state. Accordingly, such malfunction of the asset may not be detected until such malfunction affects the industrial process.

Known methods for determining if an asset has malfunctioned involve manual inspection of assets. The manual inspection is done either periodically or when a trigger related to deviations in the operational parameters of the asset is received. While such methods may allow identification of malfunctioned assets in smaller industrial facilities, such methods are not efficient for identification of malfunctioned assets in large industrial facilities comprising intricate network of assets.

Other known methods for identification of malfunctioned assets involves polling each asset present within the industrial facility and identifying the malfunctioned assets based on a response received from each of the assets. However, polling is a periodic operation and does not allow detection of malfunctioned assets proactively. Further, polling can only be performed on the assets which are directly accessible to the supervisory equipment and support communication protocols utilized by the supervisory equipment for monitoring the assets. Accordingly, such methods for identification of malfunctioned assets are also limited by connectivity between the assets and the supervisory equipment.

According to examples of the present subject matter, techniques for determining an anomaly in operation of an asset are described.

In an example, operation of an asset present within an industrial facility may be monitored to identify a silence period for the asset, where the silence period is indicative of a time duration when the asset exhibits no network activity. Upon identification of the silence period, the silence period may be determined to be longer than a reference silence period, where the reference silence period is utilized for determining an anomaly in the operation of the asset. An alarm indicative of the anomaly in the operation of the asset may then be generated.

The reference silence period may be learnt by monitoring the operation of the asset for at least a predetermined learning period. The asset may be monitored for at least the predetermined learning period to identify an activity pattern for the asset during at least the predetermined learning period. The activity pattern may include a plurality of active periods and at least one silence period, where a silence period from the at least one silence period is indicative of a time duration when the asset exhibits no network activity. A reference silence period may then be identified from the at least one silence period, where the reference silence period is to be utilized for determining an anomaly in the operation of the asset. In an example, the reference silence period may be the silence period with longest time duration from the at least one silence period. A time duration of the reference silence period may then be referenced as threshold for monitoring the asset for determination of an anomaly in the operation of the asset.

In an example, it may be determined that the reference silence period is shorter than a scaling threshold. In the example, the reference silence period may be scaled based on a scaling coefficient to generate a scaled reference silence period. A time duration of the scaled reference silence period may then be referenced as threshold for monitoring the asset for determination of an anomaly in the operation of the asset.

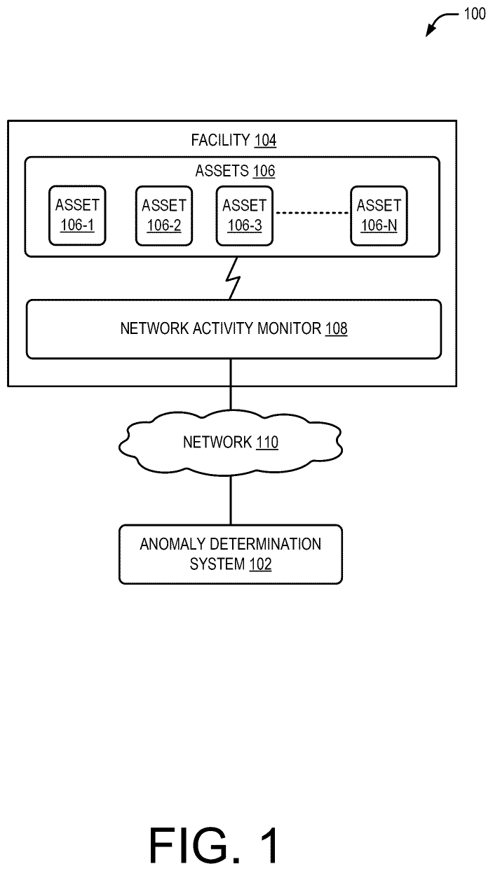

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment for implementing an Anomaly Determination System (ADS) 102, in accordance with an example of the present subject matter.

The environment 100 may include a facility 104, where the facility 104 may have a plurality of assets 106-1, 106-2, 106-3, . . . , 106-n. For the ease of reference, the plurality of assets 106-1, 106-2, 106-3, . . . , 106-n has been referred to as the plurality of assets 106, hereinafter. Examples of the facility 104 may include, but are not limited to, automobile assembly facilities, electronics manufacturing facilities, pharmaceutical production facilities, food processing plants, power plants, oil refineries, natural gas processing plants, steel mills, smelting plants, cement plants, water treatment facilities, wastewater treatment plants, warehouse and distribution centres, and port and shipping facilities. Further, examples of the assets 106 at the facility 104 may vary based on a type of facility 104 and an industrial process to be carried out at the facility. For instance, in an automobile assembly facility, assets may include robotic arms, conveyor belts, welding machines, and paint sprayers; in a pharmaceutical production facility, assets may include mixing tanks, centrifuges, tablet presses, and packaging machines; in a power plant, assets may include turbines, generators, boilers, and cooling towers; in a food processing plant, assets may include ovens, mixers, packaging machines, and refrigeration units; in a warehouse and distribution center, assets may include conveyor systems, automated guided vehicles (AGVs), sorting machines, and inventory management systems; in an oil refinery, assets may include distillation columns, heat exchangers, pumps, and compressors; and in a water treatment facility, assets may include filtration systems, chemical dosing equipment, pumps, and monitoring sensors.

Although not shown, each of the plurality of assets 106 may also be connected to each other either through a direct communication link, or through multiple communication links of a first network (not shown). The first network may be a wireless or a wired network, or a combination thereof. The first network can be a collection of individual networks, interconnected with each other and functioning as a single large network. Examples of such individual networks include, but are not limited to, Industrial Ethernet networks, fieldbus networks (e.g., Profibus, Foundation Fieldbus), wireless sensor networks (e.g., WirelessHART, ISA100.11a), Controller Area Network (CAN), Modbus networks, PROFINET, EtherCAT, DeviceNet, Open Platform Communications Unified Architecture (OPC UA) networks, Time-Sensitive Networking (TSN), Industrial Internet of Things (IIoT) networks, 5G private networks, Serial communication networks (e.g., RS-232, RS-485), and Power Line Communication (PLC) networks. In some cases, the first network may also include proprietary industrial communication protocols developed by specific manufacturers for their equipment. The first network may also incorporate redundancy features, such as ring topologies or mesh networks, to ensure continuous communication even in case of network failures.

The environment 100 may further include a network activity monitor 108 communicatively coupled to each of the assets 106 and the first network. In an example, the network activity monitor 108 may monitor the network activity of each of the plurality of assets 106 and generate network statistics associated with each of the plurality of assets 106. Examples of the network activity monitor 108 may include, but not limited to, network taps, packet brokers, network switches with port mirroring capabilities, routers, and network probes. In some implementations, the network activity monitor 108 may also include software-based network monitoring tools, virtual network taps in virtualized environments, or cloud-based network monitoring services for hybrid or cloud-deployed industrial systems. The network activity monitor 108 may capture various types of network statistics, such as packet counts, data transfer rates, protocol-specific metrics, error rates, and latency measurements.

The network activity monitor 108 may further be communicatively coupled to the ADS 102. The network activity monitor 108 may be communicatively coupled to the ADS 102 either through a direct communication link, or through multiple communication links of a second network 110. The second network 110 may be a wireless or a wired network, or a combination thereof. The second network 110 can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the communication network includes various network entities, such as gateways and routers; however, such details have been omitted to maintain the brevity of the description. In some implementations, the second network 110 may also include software-defined wide area networks (SD-WAN), satellite communication networks for remote industrial sites, or private LTE/5G networks for enhanced security and control in industrial environments.

In operation, the ADS 102 may monitor operation of an asset, such as the asset 106-1, from the plurality of assets 106 to identify a silence period for the asset 106-1. The silence period is indicative of a time duration when the asset exhibits no network activity. In an example, to identify the silence period, the ADS 102 may receive network statistics associated with the asset 106-1 from the network activity monitor 108. The ADS 102 may then analyze the network statistics to identify a first timestamp corresponding to last network packet transmitted by the asset on the first network. The ADS 102 may then identify a second timestamp corresponding to a current network time of the first network. Thereafter, the ADS 102 may compute a difference between the first timestamp and the second timestamp to identify the silence period. For instance, if the last network packet was transmitted at 10:00:00 AM and the current network time is 10:05:30 AM, the silence period would be 5 minutes and 30 seconds.

The ADS 102 may then determine if the silence period is longer than a reference silence period, where the reference silence period is utilized for determining an anomaly in the operation of the asset. In an example, to determine the reference silent period, the ADS 102 may monitor operation of the asset 106-1 to identify an activity pattern for the asset during at least a predetermined learning period. The activity pattern may include a plurality of active periods and at least one silence period, where a silence period from the at least one silence period is indicative of a time duration when the asset 106-1 exhibits no network activity. The ADS 102 may then analyze the activity pattern to identify a reference silence period, where the reference silence period is utilized for determining an anomaly in the operation of the asset 106-1.

The manner in which the learning engine identifies the reference silence period is explained in conjunction with the forthcoming figures. If it is determined that the silence period is longer than the reference silence period, the ADS 102 may generate an alarm indicative of the anomaly in the operation of the asset. For instance, if the reference silence period is 5 minutes and the current silence period is 7 minutes, the ADS 102 may generate an alarm.

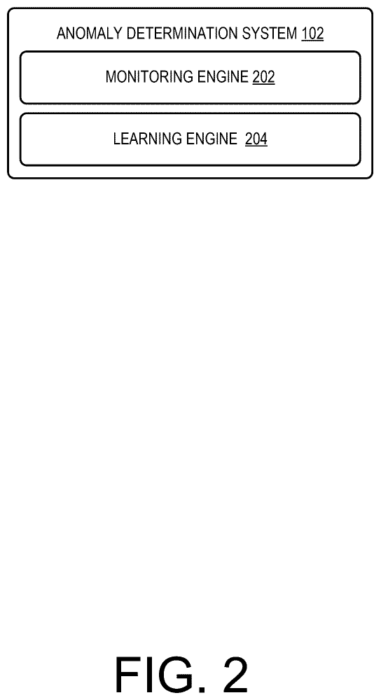

FIG. 2 illustrates schematics of the ADS 102, in accordance with an example of the present subject matter. In an example, the ADS 102 may compute the reference silence period to be utilized for determining an anomaly in operation of an asset, such as the asset 106-1.

The ADS 102 may include a monitoring engine 202 to monitor operation of the asset 106-1 to identify an activity pattern for the asset 106-1 during at least the predetermined learning period. In an example, the activity pattern may include a plurality of active periods and at least one silence period. In the example, a silence period from the at least one silence period is indicative of a time duration when the asset exhibits no network activity. That is, the silence period from is indicative of the time duration when the asset 106-1 does not transmit data packets through the network, such as the first network.

The ADS 102 may further include a learning engine 204 coupled to the monitoring engine 202. The learning engine 204 may identify a reference silence period from the at least one silence period, where the reference silence period may be utilized for determining an anomaly in the operation of the asset. In an example, the reference silence period may be a silence period with longest time duration from the at least one silence period. The learning engine 204 may then reference a time duration of the reference silence period as threshold for monitoring the asset 106-1 for determination of an anomaly in the operation of the asset 106-1.

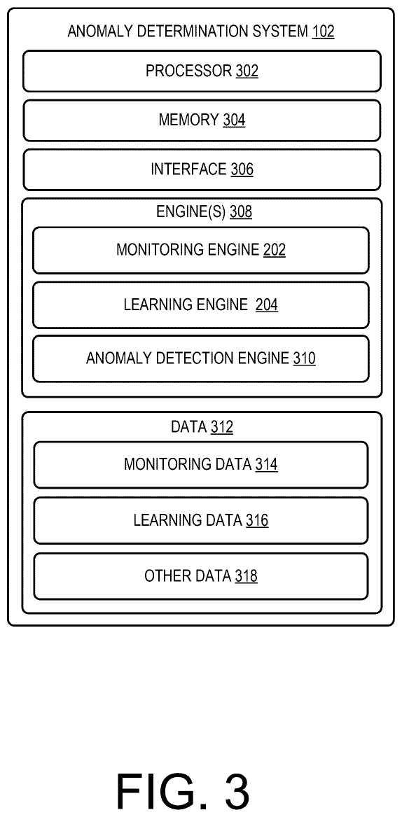

FIG. 3 illustrates the schematics of the ADS 102, in accordance with another example of the present subject matter. As illustrated, the ADS 102 may include a processor 302 and a memory 304 coupled to the processor 302. The functions of the various elements shown in the FIGS., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included. For instance, the processor 302 may be a multi-core processor capable of parallel processing, or a specialized industrial controller designed for real-time monitoring and control.

The memory 304 may include any computer-readable medium including, for example, volatile memory (e.g., RAM), and/or non-volatile memory (e.g., EPROM, flash memory, etc.).

The ADS 102 may further include an interface 306. The interface 306 may allow the connection or coupling of the ADS 102 with one or more other devices, through a wired (e.g., Local Area Network, i.e., LAN) connection or through a wireless connection (e.g., Bluetooth®, WiFi). The interface 306 may also enable intercommunication between different logical as well as hardware components of the ADS 102. In some implementations, the interface 306 may include industrial-grade communication ports such as EtherNet/IP, Modbus TCP, or OPC UA for seamless integration with various industrial control systems. It may also support secure remote access protocols like SSH for maintenance and troubleshooting purposes.

The ADS 102 may further include engine(s) 308, where the engine(s) 308 may include the monitoring engine 202, the learning engine 204, and an anomaly detection engine 310 coupled to the learning engine 204. In an example, the engine(s) 308 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the ADS 102 may include the machine-readable storage medium storing the instructions and the processing resource to execute the instructions. In other examples of the present subject matter, the machine-readable storage medium may be located at a different location but accessible to the ADS 102 and the processor 302.

The ADS 102 may further include data 312, that serves, amongst other things, as a repository for storing data that may be fetched, processed, received, or generated by the engine(s) 308. The data 312 may include monitoring data 314, learning data 316, and other data 318. In an example, the data 312 may be stored in the memory 304. The monitoring data 314 may include raw network statistics, pre-processed activity patterns, and time-series data of asset behaviour. The learning data 316 may store historical reference silence periods, machine learning models for anomaly detection, and adaptive thresholds. The other data 318 may include system configuration settings, user preferences, and logs of detected anomalies.

In operation, the monitoring engine 202 may monitor the operation of the asset 106-1 to identify an activity pattern for the asset 106-1 during at least the predetermined learning period. In an example, the activity pattern may include the plurality of active periods and the at least one silence period. In the example, a silence period from the at least one silence period is indicative of a time duration when the asset exhibits no network activity. That is, the silence period is indicative of the time duration when the asset 106-1 does not transmit data packets through the network, such as the first network.

To identify the at least one silence period, the monitoring engine 202 may receive the network statistics associated with the asset 106-1 from the network activity monitor 108. In an example, the monitoring engine 202 may then store the network statistics in the monitoring data 314. Thereafter, the monitoring engine 202 may analyze the network statistics to identify a third timestamp corresponding to a first network packet transmitted by the asset and a fourth timestamp corresponding to a second network packet transmitted after the first network packet. The monitoring engine 202 may then identify the at least one silence period by computing a difference between the third timestamp and the fourth timestamp.

In an example, the network statistics may include last activity timestamp of the IP address of the asset 106-1, where the last activity corresponds to transmission of the second network packet by the asset 106-1 on the first network. In another example, the network statistics may include the last activity timestamp of the MAC address of the asset 106-1. The learning engine 204 may identify a reference silence period from the at least one silence period, where the reference silence period may be utilized for determining an anomaly in the operation of the asset. In an example, the reference silence period may be a silence period with longest time duration from the at least one silence period. The learning engine 204 may then reference a time duration of the reference silence period as threshold for monitoring the asset 106-1 for determination of an anomaly in the operation of the asset 106-1. The learning engine 204 may then store the reference silence period in the learning data 316.

In an example, to identify the reference silence period, the learning engine 204 may initially set the predetermined learning period and begin monitoring the operation of the asset 106-1 for at least the predetermined learning period. In an example, the learning engine 204 may set the predetermined learning period as the minimum time duration entailed for completing one cycle of an industrial process corresponding to the asset 106-1. The learning engine 204 may monitor the operation of the asset 106-1 for the predetermined learning period to identify a first silence period greater than a predetermined silence period, where the predetermined silence period may be determined based on the industrial process and role of the asset in the industrial process. Once the first silence period is identified, the learning engine 204 may reset the predetermined learning period to generate a first revised learning period. The learning engine 204 may generate the first revised learning period by shortening the predetermined learning period by half of the time duration spent between a first instance when the predetermined learning period started to a second instance when the first silence period is identified. Thereafter, the learning engine 204 may restart monitoring the operation of the asset 106-1 for the first revised learning period to identify a second silence period greater than the first silence period. Once the second silence period is identified, the learning engine 204 may reset the first revised learning period to generate a second revised learning period. The learning engine 204 may generate the second revised learning period by shortening the first revised learning period by half of the time duration spent between the second instance to a third instance when the second silence period is identified. In an example, the learning engine 204 may continue generating the revised learning periods and monitoring the asset 106-1 for the revised learning periods until a first silence period corresponding to a revised learning period and a second silence period corresponding to the subsequent revised learning period are determined to be equal. In such a situation, the learning engine 204 may identify the second silence period as the reference silence period and reference the time duration of the reference silence period as the threshold for monitoring the asset 106-1 for determination of the anomaly in the operation of the asset 106-1.

In an illustrative example, the learning engine 204 may initially set the predetermined learning period to 7 days and the predetermined silence period to 0.5 hours. The learning engine 204 may then begin monitoring the asset 106-1 for the predetermined learning period. In an example, at the end of first day from the predetermined learning period, the learning engine 204 may identify the first silence period of 1 hour. Accordingly, the learning engine 204 may reset the predetermined learning period to generate a first revised learning period of 6.5 days by shortening the predetermined learning period by half of the time duration spent between the first instance when the predetermined learning period started to the second instance when the first silence period is identified, i.e., by ½ days. The learning engine 204 may then begin monitoring the asset 106-1 for the first revised learning period, i.e., for the next 6.5 days. In an example, at the end of seventh day from the predetermined learning period, the learning engine 204 may identify the second silence period of 1.1 hour. Accordingly, the learning engine 204 may reset the predetermined learning period to generate a second revised learning period of 3.5 days by shortening the first revised learning period by half of the time duration spent between the second instance to a third instance when the second silence period is identified, i.e., by 6.5/2 days. In an example, the learning engine 204 may then begin monitoring the asset 106-1 for the second revised learning period, i.e., for next 3.25 days. In the example, at the end of 3.25 days, the second silence period may not change. Accordingly, the learning engine 204 may stop monitoring the operation of the asset 106-1 at the end of 10.25 days and may identify the second silence period as the reference silence period.

The anomaly detection engine 310 may then monitor the network activity of the asset to identify a silence period longer than the reference silence period. If the anomaly detection engine 310 identifies any silence period longer than the reference silence period, the anomaly detection engine 310 may generate an alarm indicative of the anomaly in the operation of the asset.

To identify the silence period, the anomaly detection engine 310 may receive the network statistics associated with the asset 106-1 from the network activity monitor 108. The anomaly detection engine 310 may then analyze the network statistics to identify the first timestamp corresponding to last network packet transmitted by the asset 106-1 on the first network. The anomaly detection engine 310 may then identify the second timestamp corresponding to a current time of the first network. Thereafter, the anomaly detection engine 310 may identify the silence period by computing a difference between the first timestamp and the second timestamp.

In an example, the network statistics may include last activity timestamp of the IP address of the asset 106-1, where the last activity corresponds to transmission of the last network packet by the asset 106-1 on the first network. In another example, the network statistics may include the last activity timestamp of the MAC address of the asset 106-1.

In an example, prior to referencing the time duration of the reference silence period as threshold for monitoring the asset 106-1, the learning engine 204 may determine if the reference silence period is shorter than a scaling threshold. If the learning engine 204 determines the reference silence period to be shorter than the scaling threshold, the learning engine 204 may scale the reference silence period based on a scaling coefficient to generate a scaled reference silence period. The learning engine 204 may compute the scaling coefficient using the following equation:

$$Scaling Coefficient = min ( max\_coeff , max ( ( max\_coeff - Scale\_resolution * first silence period ) , 1. ) )$$

where
max_coeff is maximum permissible value of the scaling coefficient, where the max_coeff is predetermined based on at least one of the asset or an industrial process involving the asset, and
Scale_resolution is scaling resolution determined based on a time duration when the reference silence period and the scaled reference silence period are equal.

The learning engine 204 may then generating the scaled reference silence period using the following equation:

$$Scaled reference silence period = min ( upper\_bound , max ( lower\_bound , first silence period * max\_coeff ) )$$

where
upper_bound is longest time duration for which the asset exhibits no network activity and is predetermined based on the industrial process involving the asset, and
lower_bound is the shortest time duration for which the asset exhibits no network activity and is predetermined based on the industrial process involving the asset.

The anomaly detection engine 310 may then monitor the network activity of the asset to identify a silence period longer than the scaled reference silence period. If the anomaly detection engine 310 identifies any silence period longer than the scaled reference silence period, the anomaly detection engine 310 may generate an alarm indicative of the anomaly in the operation of the asset. The manner in which the anomaly detection engine 310 determines the silence period has already been described and is not reproduced for the sake of brevity.

In an illustrative example, the learning engine 204 may determine the reference silence period to be 3 minutes. In the example, the learning engine 204 may determine that the reference silence period is less than a scaling threshold of 60 minutes. Accordingly, the learning engine 204 may scale the reference silence period to generate the scaled reference silence period.

In the example, the learning engine 204 may determine the max_coeff to be 3, upper_bound to be 1200, lower_bound to be 20, and full_scale_minutes=120. As already explained, the max_coeff, upper_bound, lower_bound, and full_scale_minutes may be determined based on at least the industrial process involving the asset 106-1. In such a situation, the learning engine 204 may determine the Scale_resolution. As already explained, the Scale_resolution may be determined based on a time duration when the reference silence period and the scaled reference silence period are equal. In an example, the scale resolution may be determined in the following manner:

$$Scale\_resolution = max\_coeff / full\_scale \_minutes = 3 / 120 = 0.025$$

The learning engine 204 may then utilize the Scale_resolution to compute the scaling coefficient in the following manner:

$$Scaling coefficient = min ( 3 , max ( ( 3 - 0.025 * 3 ) , 1 ) ) = min ( 3 , max ( 2.925 , 1 ) ) = 2.925$$

The learning engine 204 may then utilize the scaling coefficient to determine the scaled reference silence period in the following manner:

$$Scaled silence period = min ( upper\_bound , max ( lower\_bound , 3 * 2.925 ) ) = min ( 1200 , max ( 20 , 9 ) ) = 20 minutes .$$

In another illustrative example, the learning engine 204 may determine the reference silence period to be 35 minutes. In the example, the learning engine 204 may determine that the reference silence period is less than the scaling threshold of 60 minutes. Accordingly, the learning engine 204 may scale the reference silence period to generate the scaled reference silence period. In such a situation, the learning engine 204 may determine the scaling coefficient in the following manner:

$$Scaling Coefficient = min ( 3 , max ( ( 3 - 0.025 * 35 ) , 1 ) ) = min ( 3 , max ( 2.125 , 1 ) ) = 2.125$$

The learning engine 204 may then utilize the scaling coefficient to determine the scaled reference silence period in the following manner:

$$Scaled silence period = min ( upper\_bound , max ( lower\_bound , 35 * 2.125 ) )$$

In yet another illustrative example, the learning engine 204 may determine the reference silence period to be 50 minutes. In the example, the learning engine 204 may determine that the reference silence period is less than the scaling threshold of 60 minutes. Accordingly, the learning engine 204 may scale the reference silence period to generate the scaled reference silence period. In such a situation, the learning engine 204 may determine the scaling coefficient in the following manner:

$$Scaling Coefficient = min ( 3 , max ( ( 3 - 0.025 * 50 ) , 1 ) ) = min ( 3 , max ( 1.75 , 1 ) ) = 1.75$$

The learning engine 204 may then utilize the scaling coefficient to determine the scaled reference silence period in the following manner:

$$Scaled silence period = min ( upper\_bound , max ( lower\_bound , 35 * 1.75 ) ) = 87.5 minutes$$

In yet another illustrative example, the learning engine 204 may determine the reference silence period to be 85 minutes. In the example, the learning engine 204 may determine that the reference silence period is more than the scaling threshold of 60 minutes. Accordingly, the learning engine 204 may note scale the reference silence period and utilize the reference silence period for determining the anomaly in the operation of the asset 106-1.

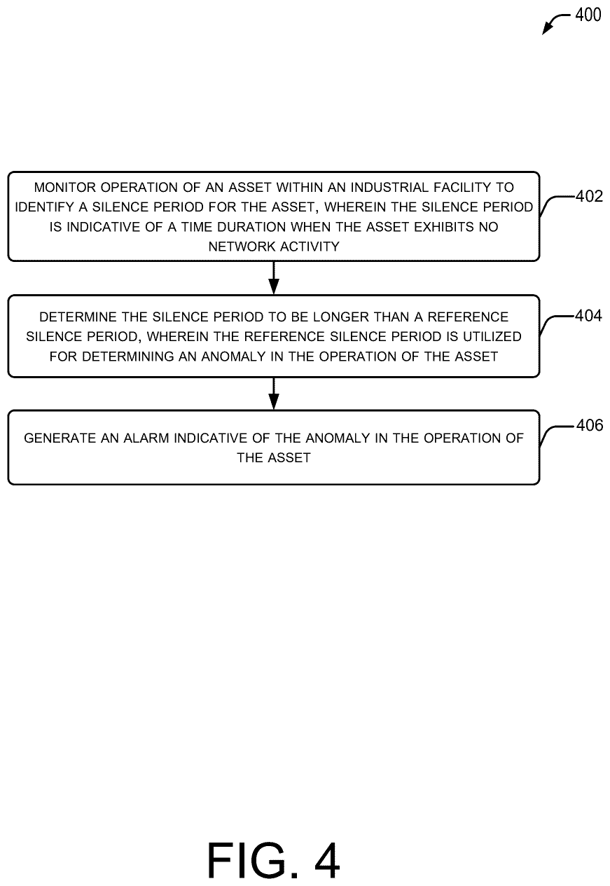

FIG. 4 illustrates a method 400 for determining the anomaly in the operation of the asset, in accordance with examples of the present subject matter. The order in which the method steps are described is not intended to be construed as a limitation, and any number of the described method blocks may be combined in any order to implement the methods, or an alternative method. Further, the method 400 may be implemented by processing resource or computing device(s) through any suitable hardware, non-transitory machine-readable instructions, or combination thereof.

It may also be understood that method 400 may be performed by programmed computing devices, such as the ADS 102. Furthermore, the method 400 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 400 is described below with reference to the ADS 102, as described above; other suitable systems for the execution of these methods may also be utilized. Additionally, implementation of the method is not limited to such examples.

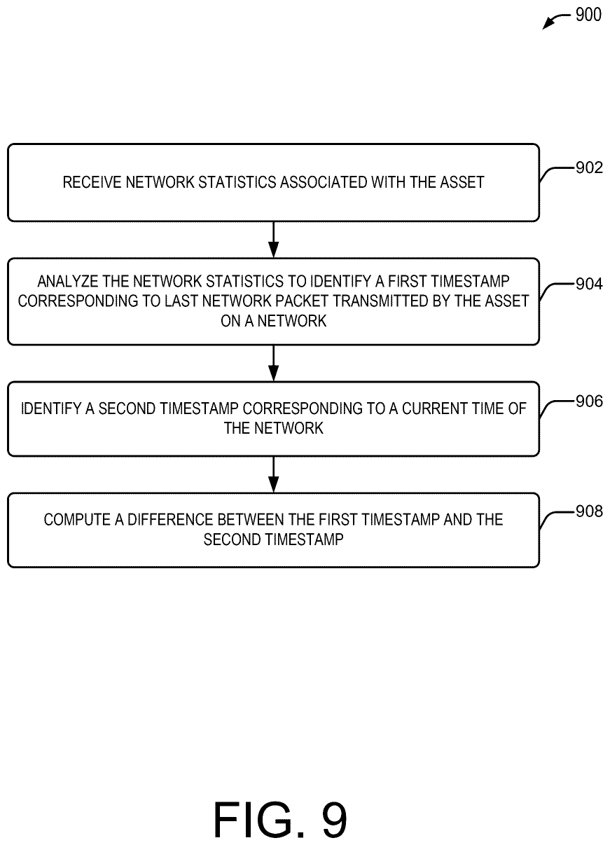

At block 402, operation of an asset is monitored to identify a silence period for an asset, where the silence period is indicative of a time duration when the asset exhibits no network activity. That is, the operation of the asset may be monitored to identify the time duration when the asset does not transmit data packets through a network, such as the first network. In an example, the operation of the asset may be monitored by the monitoring engine 202. The manner in which the silence period for the asset is identified is described in conjunction with FIG. 9.

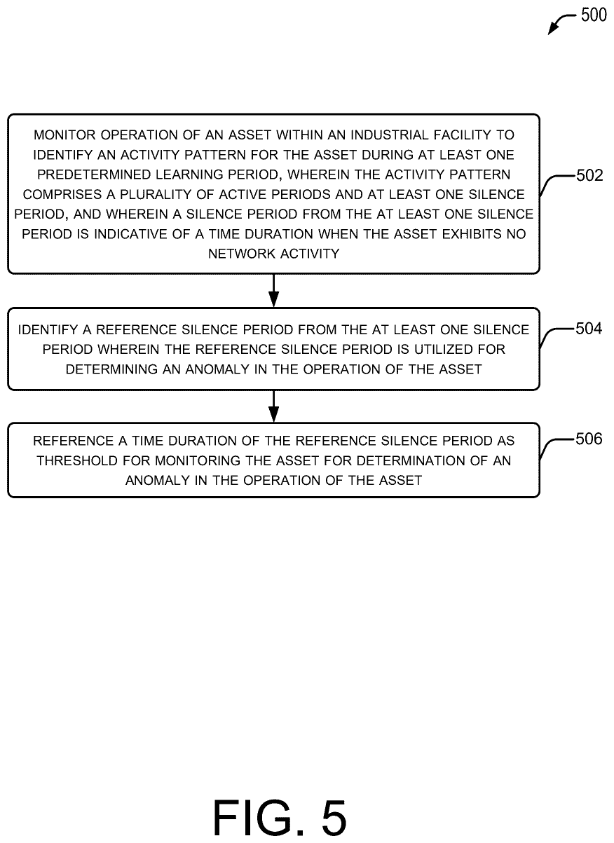

At block 404, the silence period is determined to be longer than a reference silence period, where the reference silence period is utilized for determining an anomaly in the operation of the asset. In an example, the silence period may be determined to be longer than the reference silence period by the monitoring engine 202. The manner in which the reference silence period is identified is described in conjunction with FIG. 5.

At block 406, an alarm indicative of the anomaly in the operation of the asset is generated. In an example, the alarm may be generated by anomaly detection engine 310.

FIG. 5 illustrates a method 500 for identifying the reference silence period, in accordance with an example of the present subject matter. The order in which the method steps are described is not intended to be construed as a limitation, and any number of the described method blocks may be combined in any order to implement the methods, or an alternative method. Further, the method 500 may be implemented by processing resource or computing device(s) through any suitable hardware, non-transitory machine-readable instructions, or combination thereof.

It may also be understood that method 500 may be performed by programmed computing devices, such as the ADS 102. Furthermore, the method 500 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 500 is described below with reference to the ADS 102, as described above; other suitable systems for the execution of these methods may also be utilized. Additionally, implementation of the method is not limited to such examples.

At block 502, operation of the asset is monitored to identify an activity pattern for the asset during at least a predetermined learning period. The activity pattern includes a plurality of active periods and at least one silence period, where a silence period from the at least one silence period is indicative of a time duration when the asset exhibits no network activity.

To identify the at least one silence period, the network statistics associated with the asset may be received. The network statistics may then be analyzed to identify the third timestamp corresponding to the first network packet transmitted by the asset and the fourth timestamp corresponding to the second network packet transmitted after the first network packet. Thereafter, the at least one silence period may be identified by computing a difference between the third timestamp and the fourth timestamp. The operation of the asset may be monitored by the monitoring engine 202.

At block 504, the reference silence period is identified from the at least one silence period. The reference silence period is utilized for determining an anomaly in the operation of the asset. The reference silence period may be the silence period with longest time duration from the at least one silence period. In an example, the reference silence period is identified by the learning engine 204.

At block 506, a time duration of the reference silence period is referenced as threshold for monitoring the asset for determination of the anomaly in the operation of the asset. The time duration of the reference silence period may be referenced as the threshold by the learning engine 204.

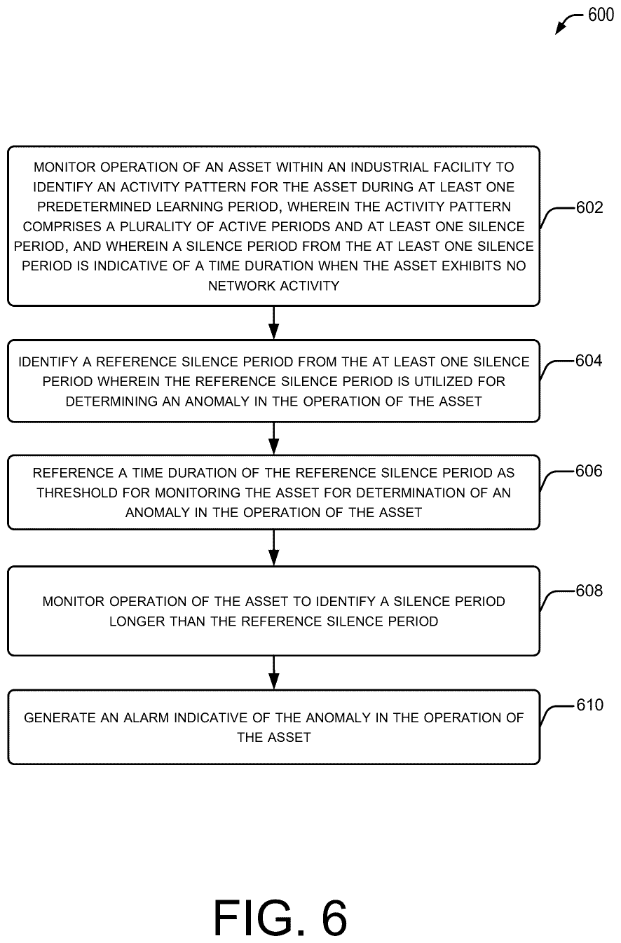

FIG. 6 illustrates a method 600 for determining the anomaly in the operation of the asset, in accordance with examples of the present subject matter. The order in which the method steps are described is not intended to be construed as a limitation, and any number of the described method blocks may be combined in any order to implement the methods, or an alternative method. Further, the method 600 may be implemented by processing resource or computing device(s) through any suitable hardware, non-transitory machine-readable instructions, or combination thereof.

It may also be understood that method 600 may be performed by programmed computing devices, such as the ADS 102. Furthermore, the method 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 600 is described below with reference to the ADS 102, as described above; other suitable systems for the execution of these methods may also be utilized. Additionally, implementation of the method is not limited to such examples.

At block 602, operation of the asset is monitored to identify the activity pattern for the asset during at least a predetermined learning period. The activity pattern includes the plurality of active periods and the at least one silence period, where a silence period from the at least one silence period is indicative of a time duration when the asset exhibits no network activity. The operation of the asset may be monitored by the monitoring engine 202.

At block 604, the reference silence period is identified from the at least one silence period. The reference silence period is utilized for determining an anomaly in the operation of the asset. The reference silence period may be the silence period with longest time duration from the at least one silence period. In an example, the reference silence period is identified by the learning engine 204.

At block 606, the time duration of the reference silence period is referenced as the threshold for monitoring the asset for determination of the anomaly in the operation of the asset. In an example, the time duration of the reference silence period is referenced as the threshold by the learning engine 204.

At block 608, operation of the asset is monitored to identify a silence period longer than the reference silence period, where the reference silence period is utilized for determining an anomaly in the operation of the asset. In an example, the operation of the asset may be monitored by the monitoring engine 202. The manner in which the silence period for the asset is identified is described in conjunction with FIG. 9.

At block 610, the alarm indicative of the anomaly in the operation of the asset is generated. In an example, the alarm may be generated by anomaly detection engine 310.

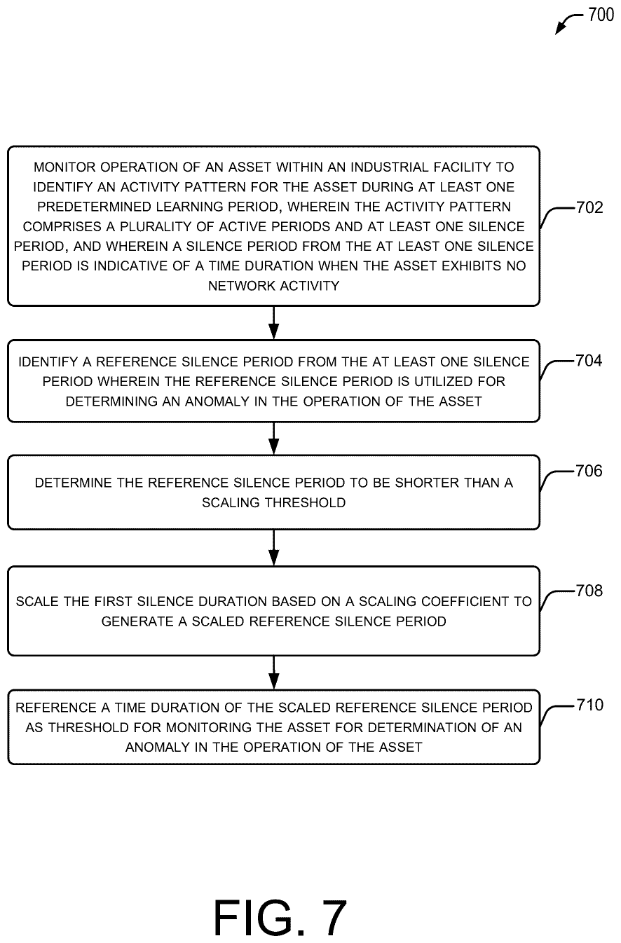

FIG. 7 illustrates a method 700 for identifying the reference silence period, in accordance with an example of the present subject matter. The order in which the method steps are described is not intended to be construed as a limitation, and any number of the described method blocks may be combined in any order to implement the methods, or an alternative method. Further, the method 700 may be implemented by processing resource or computing device(s) through any suitable hardware, non-transitory machine-readable instructions, or combination thereof.

It may also be understood that method 700 may be performed by programmed computing devices, such as the ADS 102. Furthermore, the method 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 700 is described below with reference to the ADS 102, as described above; other suitable systems for the execution of these methods may also be utilized. Additionally, implementation of the method is not limited to such examples.

At block 702, operation of the asset is monitored to identify the activity pattern for the asset during at least a predetermined learning period. The activity pattern includes the plurality of active periods and the at least one silence period, where a silence period from the at least one silence period is indicative of a time duration when the asset exhibits no network activity. The operation of the asset may be monitored by the monitoring engine 202.

To identify the at least one silence period, the network statistics associated with the asset may be received. The network statistics may then be analyzed to identify the third timestamp corresponding to the first network packet transmitted by the asset and the fourth timestamp corresponding to the second network packet transmitted after the first network packet. Thereafter, the at least one silence period may be identified by computing a difference between the third timestamp and the fourth timestamp.

At block 704, the reference silence period is identified from the at least one silence period. The reference silence period is utilized for determining an anomaly in the operation of the asset. The reference silence period may be the silence period with longest time duration from the at least one silence period. In an example, the reference silence period is identified by the learning engine 204.

At block 706, the reference silence period is determined to be shorter than the scaling threshold. In an example, the reference silence period may be determined to be shorter than the scaling threshold by the learning engine 204.

At block 708, the reference silence period is scaled based on a scaling coefficient to generate a scaled reference silence period. The scaling coefficient is computed based on at least one of the reference silence period, a maximum permissible value of the scaling coefficient, and a scale resolution. The maximum permissible value of the scaling coefficient is determined based on at least one of the asset and an industrial process involving the asset. The scale resolution is determined based on a time duration when the reference silence period and the scaled reference time period are equal. In an example, the reference silence period may be scaled by the learning engine 204.

At block 710, a time duration of the scaled reference silence period is referenced as threshold for monitoring the asset for determination of the anomaly in the operation of the asset. In an example, the time duration of the scaled reference silence period is referenced as the threshold by the learning engine 204.

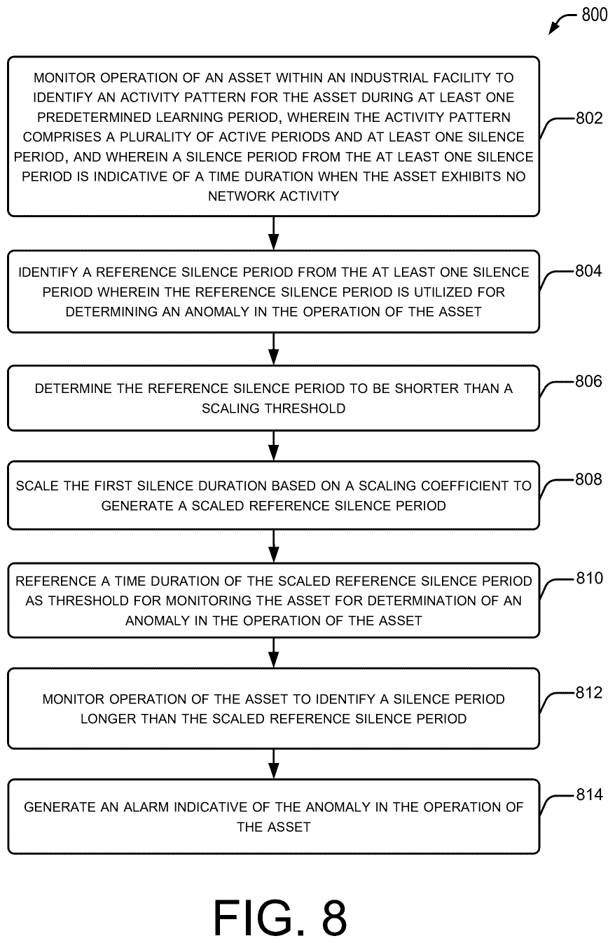

FIG. 8 illustrates a method 800 for determining the anomaly in the operation of the asset, in accordance with examples of the present subject matter. The order in which the method steps are described is not intended to be construed as a limitation, and any number of the described method blocks may be combined in any order to implement the methods, or an alternative method. Further, the method 800 may be implemented by processing resource or computing device(s) through any suitable hardware, non-transitory machine-readable instructions, or combination thereof.

It may also be understood that method 800 may be performed by programmed computing devices, such as the ADS 102. Furthermore, the method 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 800 is described below with reference to the ADS 102, as described above; other suitable systems for the execution of these methods may also be utilized. Additionally, implementation of the method is not limited to such examples.

At block 802, operation of the asset is monitored to identify the activity pattern for the asset during at least a predetermined learning period. The activity pattern includes the plurality of active periods and the at least one silence period, where a silence period from the at least one silence period is indicative of a time duration when the asset exhibits no network activity. The operation of the asset may be monitored by the monitoring engine 202.

At block 804, the reference silence period is identified from the at least one silence period. The reference silence period is utilized for determining an anomaly in the operation of the asset. The reference silence period may be the silence period with longest time duration from the at least one silence period. In an example, the reference silence period is identified by the learning engine 204.

At block 806, the reference silence period is determined to be shorter than the scaling threshold. In an example, the reference silence period may be determined to be shorter than the scaling threshold by the learning engine 204.

At block 808, the reference silence period is scaled based on the scaling coefficient to generate a scaled reference silence period. The scaling coefficient is computed based on at least one of the reference silence period, the maximum permissible value of the scaling coefficient, and the scale resolution. In an example, the reference silence period may be scaled by the learning engine 204.

At block 810, the time duration of the scaled reference silence period is referenced as threshold for monitoring the asset for determination of the anomaly in the operation of the asset. In an example, the time duration of the scaled reference silence period is referenced as the threshold by the learning engine 204.

At block 812, operation of the asset is monitored to identify a silence period longer than the scaled reference silence period, where the scaled reference silence period is utilized for determining an anomaly in the operation of the asset. In an example, the operation of the asset may be monitored by the monitoring engine 202. The manner in which the silence period for the asset is identified is described in conjunction with FIG. 9.

At block 814, the alarm indicative of the anomaly in the operation of the asset is generated. In an example, the alarm may be generated by anomaly detection engine 310.

FIG. 9 illustrates a method for identifying the silence period for the asset, in accordance with an example of the present subject matter. The order in which the method steps are described is not intended to be construed as a limitation, and any number of the described method blocks may be combined in any order to implement the methods, or an alternative method. Further, the method 900 may be implemented by processing resource or computing device(s) through any suitable hardware, non-transitory machine-readable instructions, or combination thereof.

It may also be understood that method 900 may be performed by programmed computing devices, such as the ADS 102. Furthermore, the method 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 900 is described below with reference to the ADS 102, as described above; other suitable systems for the execution of these methods may also be utilized. Additionally, implementation of the method is not limited to such examples.

At block 902, network statistics associated with the asset are received. The network statistics may be received from the network activity monitor. In an example, the network statistics may be received by the anomaly detection engine 310.

At block 904, the network statistics are analyzed to identify a first timestamp corresponding to last network packet transmitted by the asset on a network, such as the first network. In an example, the network statistics may be analyzed by the anomaly detection engine 310.

At block 906, a second timestamp corresponding to a current time of the network may be identified. In an example, the second timestamp may be identified by the anomaly detection engine 310.

At block 908, a difference between the first timestamp and the second timestamp may be computed. In an example, the difference between the first timestamp and the second timestamp may be identified as the silence period. In the example, the difference between the first timestamp and the second timestamp may be computed by the anomaly detection engine 310.

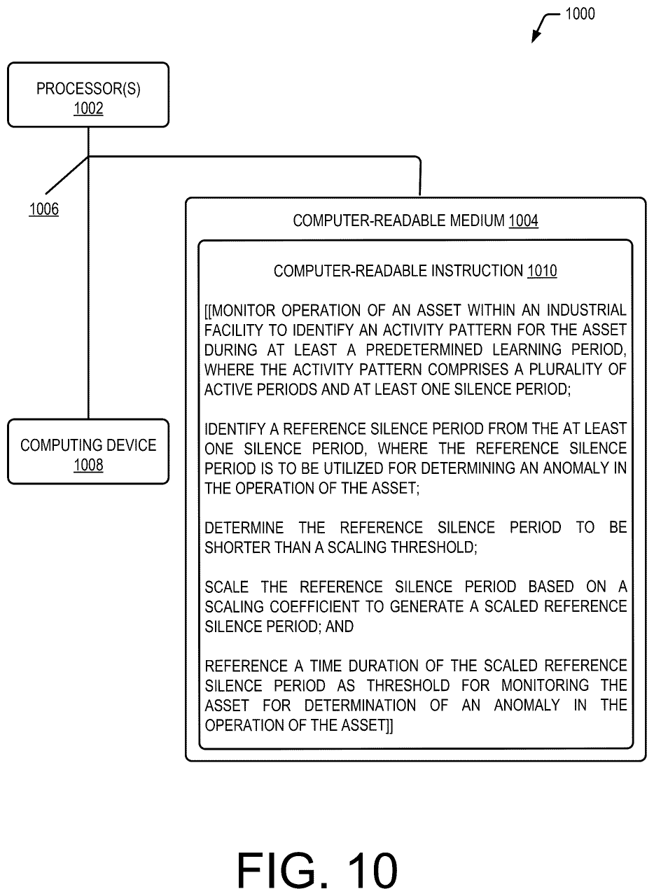

FIG. 10 illustrates a non-transitory computer-readable medium for determining the anomaly in operation of the asset, in accordance with an example of the present subject matter.

In an example, the computing environment 1000 includes processor 1002 communicatively coupled to a non-transitory computer readable medium 1004 through communication link 1006. In an example implementation, the computing environment 1000 may be for example, the ADS 102. In an example, the processor 1002 may have one or more processing resources for fetching and executing computer-readable instructions from the non-transitory computer readable medium 1004. The processor 1002 and the non-transitory computer readable medium 1004 may be implemented, for example, in the ADS 102.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1004 includes a set of computer readable instructions 1010 which may be accessed by the processor 1002 through the communication link 1006 and subsequently executed for determining the anomaly in the operation of the asset. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to monitor operation of an asset within an industrial facility to identify an activity pattern for the asset during at least a predetermined learning period. The activity pattern includes a plurality of active periods and at least one silence period, where a silence period from the at least one silence period is indicative of a time duration when the asset exhibits no network activity.

In an example, to identify the at least one silence period, the instructions 1010 may cause the processor 1002 to receive network statistics associated with the asset.

The instructions 1010 may then cause the processor 1002 to analyze the network statistics to identify a third timestamp associated with a first network packet transmitted by the asset and a fourth timestamp associated with a second network packet transmitted after the first network packet. Subsequently, the instructions 1010 may cause the processor 1002 to compute a difference between the third timestamp and the fourth timestamp to identify the at least one silence period.

The instructions 1010 may then cause the processor 1002 to identify a reference silence period from the at least one silence period, where the reference silence period is to be utilized for determining an anomaly in the operation of the asset. In an example, the reference silence period is a silence period with longest time duration from the at least one silence period. The instructions 1010 may then cause the processor 1002 to determine if the reference silence period is shorter than a scaling threshold.

If it is determined that the reference silence period is indeed shorter than the scaling threshold, the instructions 1010 may cause the processor 1002 to scale the reference silence period based on a scaling coefficient to generate a scaled reference silence period. In an example, the instructions 1010 may cause the processor 1002 to compute the scaling coefficient based on at least one of the reference silence period, a maximum permissible value of the scaling coefficient, and a scale resolution. In the example, the maximum permissible value of the scaling coefficient is determined based on at least one of the asset and an industrial process involving the asset. Further, the scale resolution is determined based on a time duration when the reference silence period and the scaled reference time period are equal.

The instructions 1010 may then cause the processor 1002 to reference a time duration of the scaled reference silence period as threshold for monitoring the asset for determination of an anomaly in the operation of the asset.

Thereafter, the instructions 1010 may cause the processor 1002 to monitor the operation of the asset after the at least the predetermined learning period to identify a silence period longer than the scaled reference silence period. Based upon the identification of the silence period longer than the scaled reference silence period, the instructions 1010 may cause the processor 1002 to generate an alarm indicative of the anomaly in the operation of the asset.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
monitoring operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity;
analyzing the activity pattern to identify a reference silence period, wherein the reference silence period is utilized for determining an anomaly in the operation of the asset;
monitoring the network activity of the asset after at least the predetermined learning period to identify a silence period longer than the reference silence period; and
generating an alarm indicative of the anomaly in the operation of the asset.

2. The method as claimed in claim 1, wherein the identifying the silence period comprises:
receiving network statistics associated with the asset;
analyzing the network statistics to identify a first timestamp corresponding to last network packet transmitted by the asset on a network;
identifying a second timestamp corresponding to a current time of the network; and
computing a difference between the first timestamp and the second timestamp.

3. The method as claimed in claim 2, wherein the network statistics comprise last activity timestamp of an Internet Protocol (IP) address of the asset, wherein the last activity corresponds to transmission of the last network packet by the asset on the network.

4. The method as claimed in claim 2, wherein the network statistics comprise last activity timestamp of a Media Access Control (MAC) address of the asset, wherein the last activity corresponds to transmission of the last network packet by the asset on the network.

5. An Anomaly Determination System (ADS) comprising:
a monitoring engine to monitor operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity;
a learning engine coupled to the monitoring engine to:
identify a reference silence period from the at least one silence period wherein the reference silence period is utilized for determining an anomaly in the operation of the asset; and
reference a time duration of the reference silence period as threshold for monitoring the asset for determination of the anomaly in the operation of the asset; and
an anomaly detection engine coupled to the learning engine to:
monitor the network activity of the asset after at least the predetermined learning period to identify a silence period longer than the threshold; and
generate an alarm indicative of the anomaly in the operation of the asset.

6. The ADS as claimed in claim 5, wherein the reference silence period is a silence period with longest time duration from the at least one silence period.

7. The ADS as claimed in claim 5, wherein the learning engine is to:
determine the reference silence period to be shorter than a scaling threshold;
scale the reference silence period based on a scaling coefficient to generate a scaled reference silence period; and
reference a time duration of the scaled reference silence period as the threshold for monitoring the asset for determination of the anomaly in the operation of the asset.

8. The ADS as claimed in claim 7, wherein prior to scaling the reference silence period, the learning engine is to compute the scaling coefficient based on at least one of the reference silence period, a maximum permissible value of the scaling coefficient, and a scale resolution,
wherein the maximum permissible value of the scaling coefficient is determined based on at least one of the asset and an industrial process involving the asset, and the scale resolution is determined based on a time duration when the reference silence period and the scaled reference silence period are equal.

9. The ADS as claimed in claim 8, wherein the learning engine is to compute the scaled reference silence period based on at least one of the maximum permissible value of the scaling coefficient, the reference silence period, an upper_bound for the at least one silence period, and a lower_bound for the at least one silence period,
wherein the upper_bound is longest time duration for which the asset exhibits no network activity and is predetermined based on the industrial process involving the asset, and the lower_bound is the shortest time duration for which the asset exhibits no network activity and is predetermined based on the industrial process involving the asset.

10. The ADS as claimed in claim 5, wherein to identify the silence period, the anomaly detection engine is to:
receive network statistics associated with the asset;
analyze the network statistics to identify a first timestamp corresponding to last network packet transmitted by the asset on a network;
identify a second timestamp corresponding to a current time of the network; and
compute a difference between the first timestamp and the second timestamp.

11. The ADS as claimed in claim 5, wherein to identify the at least one silence period, the monitoring engine is to:
receive network statistics associated with the asset;
analyze the network statistics to identify a third timestamp corresponding to a first network packet transmitted by the asset and a fourth timestamp corresponding to a second network packet transmitted after the first network packet; and
compute a difference between the third timestamp and the fourth timestamp.

12. The ADS as claimed in claim 11, wherein the network statistics comprise last activity timestamp of an Internet Protocol (IP) address of the asset, wherein the last activity corresponds to transmission of the second network packet by the asset on the network.

13. The ADS as claimed in claim 11, wherein the network statistics comprise last activity timestamp of a Media Access Control (MAC) address of the asset, wherein the last activity corresponds to transmission of the second network packet by the asset on the network.

14. A non-transitory computer readable medium comprising computer-readable instructions that when executed cause a processing resource of a computing device to:
monitor operation of an asset within an industrial facility to identify an activity pattern for the asset during at least a predetermined learning period, wherein the activity pattern comprises a plurality of active periods and at least one silence period, and wherein a silence period from the at least one silence period is indicative of a time duration when the asset exhibits no network activity;
identify a reference silence period from the at least one silence period, wherein the reference silence period is to be utilized for determining an anomaly in the operation of the asset;
determine the reference silence period to be shorter than a scaling threshold;
scale the reference silence period based on a scaling coefficient to generate a scaled reference silence period;
reference a time duration of the scaled reference silence period as threshold for monitoring the asset for determination of the anomaly in the operation of the asset;
monitor the network activity of the asset after at least the predetermined learning period to identify a silence period longer than the threshold; and
generate an alarm indicative of the anomaly in the operation of the asset.

15. The non-transitory computer readable medium as claimed in claim 14, wherein the reference silence period is a silence period with longest time duration from the at least one silence period.

16. The non-transitory computer readable medium as claimed in claim 14, wherein the instructions further cause the processing resource to compute the scaling coefficient based on at least one of the reference silence period, a maximum permissible value of the scaling coefficient, and a scale resolution,
wherein the maximum permissible value of the scaling coefficient is determined based on at least one of the asset and an industrial process involving the asset, and the scale resolution is determined based on a time duration when the reference silence period and the scaled reference time period are equal.

17. The non-transitory computer readable medium as claimed in claim 16, wherein the instructions further cause the processing resource to compute the scaled reference silence period based on at least one of the maximum permissible value of the scaling coefficient, the reference silence period, an upper_bound for the at least one silence period, and a lower_bound for the at least one silence period,
wherein the upper_bound is longest time duration for which the asset exhibits no network activity and is predetermined based on the industrial process involving the asset, and the lower_bound is the shortest time duration for which the asset exhibits no network activity and is predetermined based on the industrial process involving the asset.

18. The non-transitory computer readable medium as claimed in claim 14, wherein to identify the at least one silence period, the instructions cause the processing resource to:
receive network statistics associated with the asset;
analyze the network statistics to identify a third timestamp associated with a first network packet transmitted by the asset and a fourth timestamp associated with a second network packet transmitted after the first network packet; and
compute a difference between the third timestamp and the fourth timestamp.

19. The non-transitory computer readable medium as claimed in claim 18, wherein network statistics comprise last activity timestamp of an IP address of the asset, wherein the last activity corresponds to transmission of the second network packet by the asset on the network.

20. The non-transitory computer readable medium as claimed in claim 18, wherein the network statistics comprise last activity timestamp of a MAC address of the asset, wherein the last activity corresponds to transmission of the second network packet by the asset on the network.
